(19) United States
(12) Patent Application Publication
(10) Pub. No.: US 2024/0152133 A1
(43) Pub. Date: May 9, 2024

(54) THRESHOLD ACQUISITION APPARATUS, METHOD AND PROGRAM FOR THE SAME

(71) Applicant: NIPPON TELEGRAPH AND TELEPHONE CORPORATION, Tokyo (JP)

(72) Inventors: Shin MURATA, Tokyo (JP); Yuma KOIZUMI, Tokyo (JP); Noboru HARADA, Tokyo (JP); Shoichiro SAITO, Tokyo (JP)

(73) Assignee: NIPPON TELEGRAPH AND TELEPHONE CORPORATION, Tokyo (JP)

(21) Appl. No.: 17/769,295

(22) PCT Filed: Oct. 16, 2019
(86) PCT No.: PCT/JP2019/040654

§ 371 Date: Apr. 14, 2022

(51) Int. Cl. G06F 11/07

(52) U.S. Cl. CPC G06F 11/076; G06F 11/0706

(57) ABSTRACT

A threshold acquisition apparatus acquires a threshold for determining whether an anomaly score acquired from a target sound is normal or anomalous. The threshold acquisition apparatus includes: an allowable number setting unit that sets an allowable number of times such that the number of anomaly scores determined to be anomalous included in a set of anomaly scores per predetermined section length, which is a part of time-series acoustic signals that do not include an anomalous sound, does not exceed the allowable number of times; and a threshold estimation unit that estimates a threshold candidate such that the number of sections determined to be anomalous per predetermined section length, which is a part of time-series acoustic signals, satisfies a predetermined criterion by using the allowable number of times, and acquires the threshold candidate as the threshold.

### TECHNICAL FIELD

The present invention relates to a threshold acquisition apparatus, a method thereof, and a program for acquiring a threshold for anomaly determination used in an anomaly detection system.

### BACKGROUND ART

Anomaly detection is performed for determining an anomaly in a target from data. FIG. 1 illustrates a configuration example of an anomaly detection system. The anomaly detection system receives some kind of target data such as audio, video, and logs as input, obtains the degree of anomaly, determines whether the target data is normal or anomalous from the degree of anomaly by using a threshold, and outputs the determination result. Target data acquired in a normal state is called normal data, and target data acquired in an anomalous state is called anomalous data. An anomaly score represents the degree of anomaly, for example, the degree of deviation from normal data.

In the anomaly detection, anomaly determination is performed based on a magnitude relation between an anomaly score indicating the degree of anomaly and a certain threshold. Therefore, determination of the threshold is an important issue in the accuracy of the anomaly detection. For example, in a case where a value that increases as the degree of anomaly increases is used as an anomaly score, if the threshold is set sufficiently small, while overlooking of anomalous data is reduced, erroneous determination of normal data as anomalous data increases, instead. If the threshold is set large, while erroneous determination of normal data as anomalous data is reduced, overlooking of anomalous data increases, instead. Therefore, the threshold needs to be set to an appropriate level. In this case, the threshold is commonly set in advance (see NPL 1).

### CITATION LIST

### Non Patent Literature

[NPL 1] Raghavendra Chalapathy and Sanjay Chawla., “Deep Learning for Anomaly Detection: A Survey”, arXiv:1901.03407 [cs, stat], January 2019. arXiv: 1901.03407.

### SUMMARY OF THE INVENTION

### Technical Problem

However, setting an appropriate threshold causes a large cost in introducing the anomaly detection system.

It is an object of the present invention to provide a threshold acquisition apparatus, a method thereof, and a program capable of automatically acquiring an appropriate threshold for anomaly determination.

### Means for Solving the Problem

To solve the above problem, according to one aspect of the present invention, a threshold acquisition apparatus acquires a threshold for determining whether an anomaly score acquired from a target sound is normal or anomalous. The threshold acquisition apparatus includes: an allowable number setting unit that sets an allowable number of times such that the number of anomaly scores determined to be anomalous included in a set of anomaly scores per predetermined section length, which is a part of time-series acoustic signals that do not include an anomalous sound, does not exceed the allowable number of times; and a threshold estimation unit that estimates a threshold candidate such that the number of sections determined to be anomalous per predetermined section length, which is a part of time-series acoustic signals, satisfies a predetermined criterion by using the allowable number of times, and acquires the threshold candidate as the threshold.

To solve the above problem, according to one aspect of the present invention, a threshold acquisition apparatus includes: a parameter estimation unit that obtains a mean detection rate λ (θ′) at a threshold candidate θ′ from a set of anomaly scores Yᵢ=[y_{i,1}, . . . , y_{i,T}] per predetermined section length T, which is a part of time-series acoustic signals; a cumulative distribution calculation unit that models the number of times k that an anomaly is detected in a predetermined section length T by a Poisson distribution based on the mean detection rate λ(θ′) and calculates a probability p (k>kₐ; Tλ(θ′)) that the number of times k is greater than an allowable number of times kₐ; an allowable number acquisition unit that acquires a minimum allowable number of times kₐ at which a probability p (k>kₐ; Tλ(θ′)) is equal to or less than a predetermined significance level α; a detection number counting unit that calculates, when P is an integer of 2 or more, and p=1, . . . , P, the number of times kₛ (θₚ) that an anomaly is detected in anomaly scores Zₛ=[z_{s,1}, . . . , z_{s,T}] per predetermined section length T for each of P threshold candidates θₚ; an anomaly determination unit that determines that acoustic signals corresponding to the anomaly scores Zₛ=[z_{s,1}, . . . , z_{s,T}] are anomalous when the number of times kₛ (θₚ) exceeds the allowable number of times kₐ; a performance index calculation unit that calculates a performance index FPR (θₚ) from a determination result aₛ (θₚ) obtained in the anomaly determination unit; and a threshold estimation unit that selects a threshold candidate θₚ for achieving a desired performance index q by using the performance index FPR (θₚ) from among the P threshold candidates θp to be the threshold candidate θ′, repeats processing until estimation of a threshold candidate converges, and acquires a threshold candidate at a time of convergence as a threshold.

To solve the above problem, according to one aspect of the present invention, a threshold acquisition apparatus acquires a threshold for determining whether an anomaly score acquired from target data is normal or anomalous. The threshold acquisition apparatus includes: an allowable number setting unit that sets an allowable number of times such that the number of anomaly scores determined to be anomalous included in a set of anomaly scores per predetermined section length, which is a part of time-series data that do not include anomalous data, does not exceed the allowable number of times; and a threshold estimation unit that estimates a threshold candidate such that the number of sections determined to be anomalous per predetermined section length, which is a part of time-series data, satisfies a predetermined criterion by using the allowable number of times, and acquires the threshold candidate as the threshold.

To solve the above problem, according to one aspect of the present invention, a threshold acquisition apparatus includes: a parameter estimation unit that obtains a mean detection rate λ (θ′) at a threshold candidate θ′ from a set of anomaly scores Yᵢ=[y_{i,1}, . . . , y_{i,T}] per predetermined section length T, which is a part of time-series data; a cumulative distribution calculation unit that models the number of times k that an anomaly is detected in a predetermined section length T by a Poisson distribution based on the mean detection rate λ(θ′) and calculates a probability p (k>kₐ; Tλ(θ′)) that the number of times k is greater than an allowable number of times kₐ; an allowable number acquisition unit that acquires a minimum allowable number of times kₐ at which a probability p (k>kₐ; Tλ(θ′)) is equal to or less than a predetermined significance level α; a detection number counting unit that calculates, when P is an integer of 2 or more, and p=1, . . . , P, the number of times kₛ (θₚ) that an anomaly is detected in anomaly scores Zₛ=[z_{s,1}, . . . , z_{s,T}] per predetermined section length T for each of P threshold candidates θₚ; an anomaly determination unit that determines that data corresponding to the anomaly scores Zₛ=[z_{s,1}, . . . , z_{s,T}] are anomalous when the number of times kₛ (θₚ) exceeds the allowable number of times kₐ; a performance index calculation unit that calculates a performance index FPR (θₚ) from a determination result aₛ (θₚ) obtained in the anomaly determination unit; and a threshold estimation unit that selects a threshold candidate θp for achieving a desired performance index q by using the performance index FPR (θₚ) from among the P threshold candidates θₚ to be the threshold candidate θ′, repeats processing until estimation of a threshold candidate converges, and acquires a threshold candidate at a time of convergence as a threshold.

### Effects of the Invention

According to the present invention, there is provided an effect that an appropriate threshold can be automatically acquired for anomaly determination.

### BRIEF DESCRIPTION OF DRAWINGS

FIG. 1 illustrates a configuration example of an anomaly detection system.

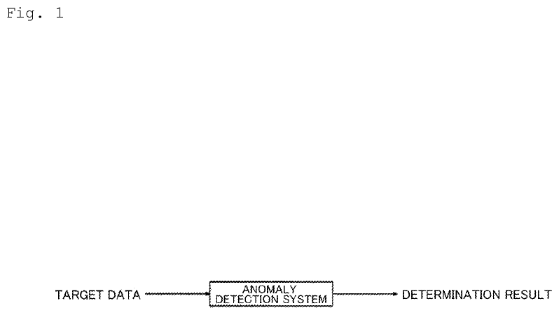

FIG. 2 illustrates a probability density function of a Poisson distribution.

FIG. 3 illustrates an example of a cumulative distribution function of a Poisson distribution.

FIG. 4 is a diagram for describing data when the anomaly detection system is in operation.

FIG. 5 is a functional block diagram of a threshold acquisition apparatus according to a first embodiment.

FIG. 6 is a flowchart illustrating an example of processing performed by the threshold acquisition apparatus according to the first embodiment.

FIG. 7 illustrates an example of an anomaly score histogram.

FIG. 8 illustrates an example in which a relation between a threshold and a mean detection rate is plotted.

FIG. 9 illustrates an example of a correspondence relation between a threshold candidate and a false positive rate.

FIG. 10 illustrates a configuration example of a computer to which the present method is applied.

### DESCRIPTION OF EMBODIMENTS

Hereinafter, an embodiment of the present invention will be described. In the drawings used in the following description, the same reference numerals are given to the constituent elements having the same function or the steps having the same processing, and redundant descriptions will be omitted. In the following description, processing performed for each element of a vector or matrix is deemed to be applicable to all the elements of the vector or matrix unless otherwise specified.

### Feature of First Embodiment

It is not realistic to determine normality/anomaly without an error. Thus, based on prior knowledge such as statistical knowledge, first, a method in which an allowable error in a case where only normal data exists is set, and a threshold capable of determining normality/anomaly is acquired by determining whether an error deviates from the allowable error will be considered. Further, when anomalous data becomes available as the operation of the system proceeds, a method for acquiring a threshold by using the anomalous data will also be considered.

The anomaly detection system calculates an anomaly score yₜ=f (xₜ) for an input xₜ, performs determination of anomaly/normality based on the magnitude relation between the anomaly score yₜ=f (xₜ) and a threshold θ for anomaly determination, and outputs the determination result (binary data) aₜ={0,1}.

$$\\ \begin{matrix}[ Math . 1 ] & \\ {a}_{t} = \{ \begin{matrix}1 & ( f ( {x}_{t} ) \geq θ ) \\ 0 & ( otherwise )\end{matrix} & ( 1 )\end{matrix}$$

For example, the above determination result is output.

In the present embodiment, the number of anomaly detection times by the anomaly detection system is modeled by a probability distribution that takes the number of times as a random variable, such as a Poisson distribution and a binomial distribution. In the present embodiment, the threshold for the anomaly determination is automatically adjusted so that, for example, a performance index of a classification issue determined by a user such as a false positive rate becomes any value determined by the user/determined in advance.

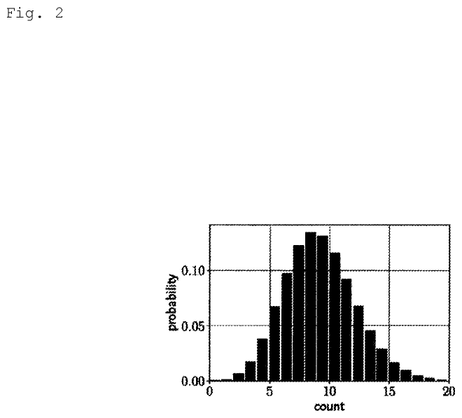

The Poisson distribution is a probability distribution indicating that a certain event has occurred k times in a predetermined unit of time, and its probability mass function is expressed as follows (see FIG. 2).

$$\\ \begin{matrix}[ Math . 2 ] & \\ {p}_{λ} ( X = k ) = \frac{{λ}^{k} {e}^{- λ}}{k !} & ( 2 )\end{matrix}$$

Note that FIG. 2 illustrates the probability density function of the Poisson distribution.

Here, p_{λ} (X=k) indicates that, when an event occurs on an average of λ times in a predetermined period of time, the event has occurred k times. Applying this to an anomaly detection model, it is deemed that the anomaly detection system may detect an anomaly λ times on average. Based on a reproductive property of the Poisson distribution, when the same detection system is operated for L hours, the probability that the detection system detects an anomaly k times is expressed as follows.

$$\\ \begin{matrix}[ Math . 3 ] & \\ {p}_{L λ} ( X = k ) = \frac{{( L λ )}^{k} {e}^{- L λ}}{k !} & ( 3 )\end{matrix}$$

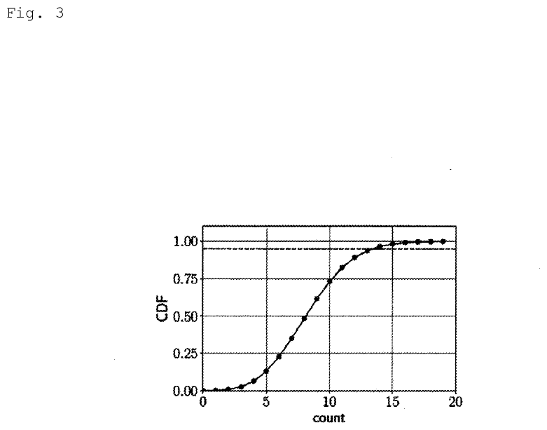

Here, considering a system that detects an anomaly λ times on average during normal operation, the probability that this system detects an anomaly kₐ times or more in a period of L hours is expressed as follows (see FIG. 3).

p(X≥kₐ)=Σ_{k≥k}_{ₐ} p_{Lλ}(X=k) [Math. 4]

For example, in the case of FIG. 3, the dashed line in FIG. 3 represents a probability of 0.95, and the probability that the anomaly is detected 13 times or more is 0.05, which indicates that this is very unlikely to occur. As described above, by modeling the number of detection times by the anomaly detection system with the Poisson distribution, it can be verified whether the operation is different from the operation in the normal state based on the number of times that the system detects the anomaly, not based on a single detection of the anomaly.

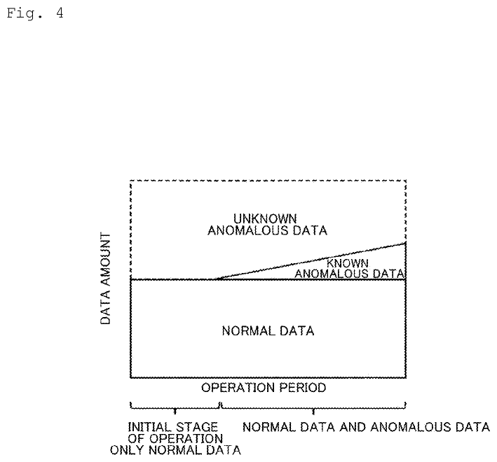

As illustrated in FIG. 4, the anomaly detection system has a feature that only normal data is obtained at the initial stage of the operation, and anomalous data is collected during the actual operation. In addition, it is difficult to cover all the anomalous data even if the anomaly detection system is operated for a long period of time.

During the period when the anomalous data in the initial stage is not collected, a threshold is automatically acquired by using the false positive rate as an evaluation index as described above.

After the anomalous data is collected, a predetermined evaluation index is calculated from the obtained small number of anomalous data and normal data, and the threshold is automatically acquired from the calculated evaluation index. Once the anomalous data has been collected, for example, the false positive rate, recall rate, precision rate, or the like can be used as the evaluation index.

### First Embodiment

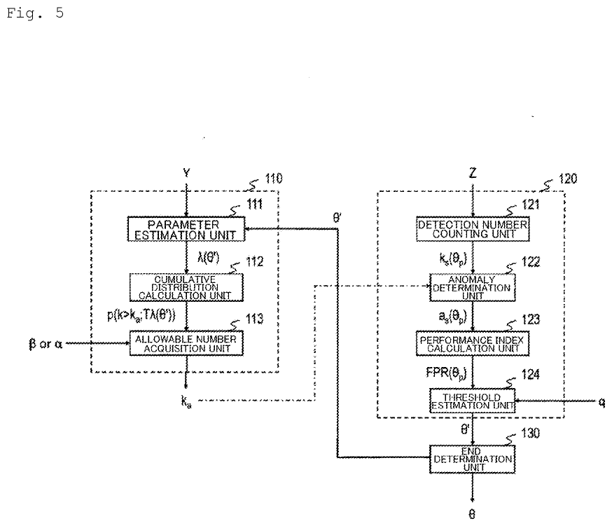

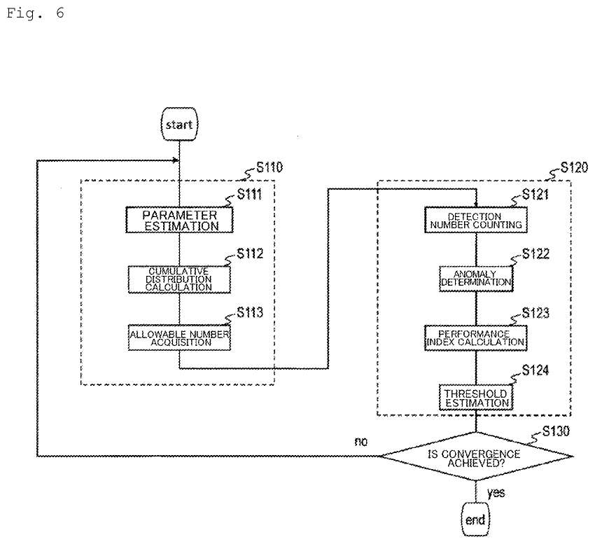

FIG. 5 is a functional block diagram of a threshold acquisition apparatus according to a first embodiment, and FIG. 6 is a flowchart illustrating processing performed by the threshold acquisition apparatus.

The threshold acquisition apparatus includes an allowable number setting unit 110, a threshold estimation unit 120, and an end determination unit 130.

In the anomaly detection system, anomaly detection is performed on a batch including a set of a plurality of data and a data set including a set of the batches. Hereinafter, an example in which an acoustic data set is used as a data set will be described. The threshold acquisition apparatus of the present embodiment receives a data set of anomaly scores corresponding to an acoustic data set as input. The acoustic data set, which is a target data in the anomaly detection system, is a set of batch data including a plurality of frames (time lengths), and final anomaly determination is made on a batch basis, not on a frame basis.

The threshold acquisition apparatus receives anomaly score data sets Y=[Y₁, . . . , Y_{N}], Z=[Z₁, . . . , Z_{S}], a desired performance index q, and a tolerance β or a significance level α for the detection as input, acquires a threshold θ that satisfies the desired performance index and the tolerance, and outputs the acquired threshold θ.

The data set Y includes N batch units of anomaly score data batches Yᵢ=[y_{i,1}, . . . , y_{i,T}], and a batch unit of anomaly score data batch Yᵢ includes anomaly score data y_{i,t} for a predetermined section length T. Here, i=1, 2, . . . , N, and t=1, 2, . . . , T. Likewise, the data set Z includes S batch units of anomaly score data batches Zₛ=[z_{s,1}, . . . , z_{s,T}], and a batch unit of anomaly score data batch Zₛ includes anomaly score data z_{s,t} for a predetermined section length T. Here, s=1, 2, . . . , S. The anomaly score data y_{i,t}, z_{s,t} are calculated on a frame basis.

The same data set or the same type of data set of anomaly scores as that used in the anomaly detection system may be used as the data set of anomaly scores included in the input to the threshold acquisition apparatus. For example, an autoencoder is used for learning the threshold, and a reconstruction error generated therefrom is used as the anomaly score.

In addition, in the present embodiment, the false positive rate set by the user is used as the performance index included in the input to the threshold acquisition apparatus. The desired false positive rate q is 0<q<1, and the tolerance β for detection is 0<β<1. The false positive rate is a rate at which normal data is erroneously detected as anomalous data. By setting the desired false positive rate low, erroneous detection is reduced, and overlooked anomalous data increases. By setting the desired false positive rate high, erroneous detection increases, and overlooked anomalous data is reduced. Further, by setting the tolerance β low, the number of detection times in the data batch is reduced, and by setting the tolerance β high, the number of detection times increases. A value obtained by subtracting the tolerance β from 1, which is α=1−β, corresponds to the significance level in a statistical test. Therefore, it can be said that obtaining the tolerance is equivalent to obtaining the significance level.

The threshold acquisition apparatus is, for example, a special apparatus configured by reading a special program into a known or dedicated computer having a central processing unit (CPU), a main storage device (RAM: random access memory), and the like. The threshold acquisition apparatus executes processing under the control of the central processing unit, for example. Data input to the threshold acquisition apparatus and data obtained in the processing is stored in, for example, the main storage device, and the data stored in the main storage device is read out to the central processing unit as needed to be used for other processing. At least a part of each processing unit of the threshold acquisition apparatus may be configured by hardware such as an integrated circuit. Each storage unit included in the threshold acquisition apparatus can be configured by, for example, a main storage apparatus such as a RAM (random access memory) or middleware such as a relational database or a key-value store. However, each storage unit does not necessarily need to be provided inside the threshold acquisition apparatus but may be configured by an auxiliary storage device composed of semiconductor memory elements such as a hard disk, an optical disk, or a flash memory and provided outside the threshold acquisition apparatus.

The allowable number setting unit 110 sets a maximum number of times (allowable number of times) that the detection system makes an erroneous detection within a predetermined period during normal operation. The threshold estimation unit 120 estimates a threshold that satisfies a desired performance index within the set allowable number of times.

The end determination unit 130 determines whether the estimation of the threshold has converged, and the threshold acquisition apparatus repeats the processing in the allowable number setting unit 110 and the threshold estimation unit 120 until the estimation of the threshold converges. The final output of the threshold acquisition apparatus is the threshold used for anomaly determination.

Hereinafter, each unit will be described.

<Allowable Number Setting Unit 110>

The allowable number setting unit 110 receives an anomaly score data set Y=[Y₁, Y₂, . . . , Y_{N}] including N normal data batches Yᵢ, a threshold candidate θ′, and a tolerance β or a significance level α(=1−β) as input. Next, the allowable number setting unit 110 sets an allowable number of times kₐ such that the number of anomaly scores determined to be anomalous included in a set of anomaly scores per predetermined section length, which is a part of the time-series target data that does not include anomalous data (per normal data batch Yᵢ), does not exceed the allowable number of times (S110) and outputs the set allowable number of times Kₐ. It can be said that the normal data batch Yᵢ is a set of anomaly scores (Yᵢ=[y_{i,1}, . . . , y_{i,T}]) per predetermined section length T, which is a part of the time-series target data that does not include anomalous data. The normal data batch is a data set of anomaly scores in batches obtained from the normal data. Here, y_{i,t} represents an anomaly score corresponding to the target data in the t-th frame of the i-th batch. The threshold candidate θ′ is a value estimated by a threshold estimation unit 124, which will be described below, and an appropriate value is given as an initial value. The appropriate value is, for example, 0, the maximum value or the most frequent value of an anomaly score in a normal data batch, etc.

The allowable number setting unit 110 includes a parameter estimation unit 111, a cumulative distribution calculation unit 112, and an allowable number acquisition unit 113 and performs the processing in S110 described above.

<Parameter Estimation Unit 111>

The parameter estimation unit 111 receives an anomaly score data set Y=[Y₁, Y₂, . . . , Y_{N}] including N normal data batches Yᵢ and a threshold candidate θ′ as input. Next, the parameter estimation unit 111 calculates a mean detection rate λ(θ′) at a certain threshold candidate θ′ from the N normal data batches Yᵢ=[y_{i,1}, y_{i,T}] (S111) and outputs the obtained mean detection rate λ(θ′).

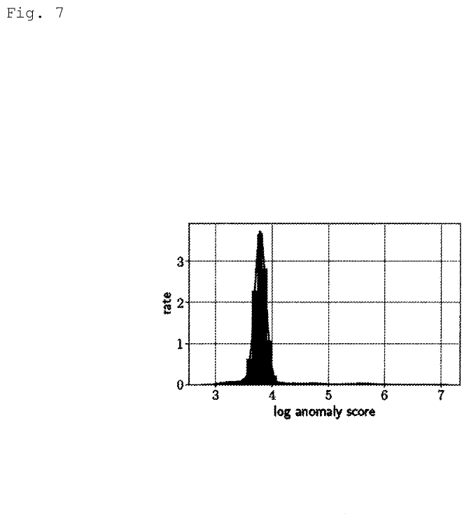

For example, the parameter estimation unit 111 obtains an anomaly score histogram from the data set Y (see FIG. 7). The mean detection rate λ(θ′) at the threshold candidate θ′ is calculated as follows:

$$\\ \begin{matrix}[ Math . 5 ] & \\ λ ( {θ}^{{}^{} ′} ) = \frac{1}{NT} {\sum }_{i}^{N} {\sum }_{t}^{T} {I}_{{θ}^{′}} ( {y}_{i , t} ) , where & ( 4 )\end{matrix}$$

$$\\ \begin{matrix}[ Math . 6 ] & \\ {I}_{{θ}^{′}} ( {y}_{i , t} ) = \{ \begin{matrix}1 & ( {y}_{i , t} \geq {θ}^{{}^{} ′} ) \\ 0 & ( {y}_{i , t} < {θ}^{{}^{} ′} )\end{matrix} & ( 5 )\end{matrix}$$

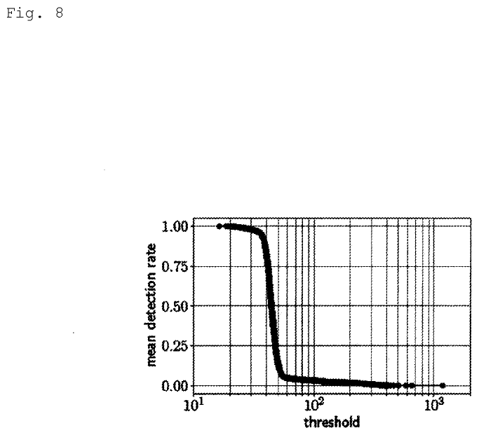

is an indicator function. FIG. 8 plots a relationship between the threshold and the mean detection rate. Once the mean detection rate λ(θ′) is determined, the number of detection times during the batch length T can be modeled by the Poisson distribution p_{Tλ(θ′)} (Y=k) (see FIG. 2).

<Cumulative Distribution Calculation Unit 112>

The cumulative distribution calculation unit 112 receives the mean detection rate λ(θ′) as input, models the number of times k that an anomaly is detected in a predetermined section length T by the Poisson distribution based on the mean detection rate λ(θ′), calculates a probability p (k>kₐ; Tλ(θ′)) that the number of times k is greater than the allowable number of times kₐ (S112), and outputs the calculation result.

When the number of detection times in the detection system during the length T is modeled by the Poisson distribution p_{Tλ(θ′)} (Y=k), a probability that the number of times k that an anomaly is detected in the length of the batch is greater than the allowable number of times kₐ can be calculated as follow.

$$\\ \begin{matrix}[ Math . 7 ] & \\ p ( k > {k}_{a} ; T λ ( {θ}^{{}^{} ′} ) ) = 1 - p ( k \leq {k}_{a} ; T λ ( {θ}^{{}^{} ′} ) ) = 1 - {\sum }_{{k}^{′} = 0}^{{k}_{a}} {p}_{r λ ( {θ}^{′} )} ( Y = {k}^{{}^{} ′} ) = 1 - CDF ( {k}_{a} ; T λ ( {θ}^{{}^{} ′} ) ) & \end{matrix}$$

Here, CDF (kₐ; Tλ(θ′)) is a cumulative distribution function of the Poisson distribution p_{Tλ(θ′)} (Y=k) (see FIG. 3).

The cumulative distribution calculation unit 112 calculates a plurality of probabilities p (k>kₐ; Tλ(θ′)) while changing the allowable number of times kₐ within an appropriate range. For example, the cumulative distribution calculation unit 112 may receive a tolerance β or a significance level α(=1−β) in advance, calculate a probability p (k>kₐ; Tλ(θ′)) at each allowable number of times kₐ while increasing the allowable number of times kₐ in the order from the allowable number of times kₐ=1, and continue the calculation until the probability p (k>kₐ; Tλ(θ′)) is equal to or less than the significance level α (=1−β). In this case, the allowable number of times kₐ at which the probability p (k>kₐ; Tλ(θ′)) reaches the significance level α (=1−β) or less corresponds to the minimum allowable number of times kₐ at which the probability p (k>kₐ; Tλ(θ′)) is equal to or less than the significance level α, which is obtained by the allowable number acquisition unit 113 described below. Therefore, the allowable number acquisition unit 113 does not need to be provided in the allowable number setting unit 110. In other words, the cumulative distribution calculation unit 112 includes the allowable number acquisition unit 113 in this case.

<Allowable Number Acquisition Unit 113>

Before setting the allowable number of times, the allowable number acquisition unit 113 receives a tolerance β or a significance level α (=1−β). The allowable number acquisition unit 113 receives a plurality of probabilities p (k>kₐ; Tλ(θ′)), acquires the minimum allowable number of times kₐ at which the probability p (k>kₐ; Tλ(θ′)) is equal to or less than a predetermined significance level α (S113), and outputs the acquired minimum allowable number of times Kₐ.

Based on the probability p (k>kₐ; Tλ(θ′)), the probability that an event in which more anomalies than the allowable number of times kₐ are detected occurs can be discussed. When this probability is equal to or less than the predetermined significance level α, such an event is determined to be very unlikely to occur. Thus, the minimum kₐ that achieves p (k>kₐ) is defined as the allowable number of detection times.

<Threshold Estimation Unit 120>

The threshold estimation unit 120 receives the anomaly score data set Z=[Z₁, . . . , Z_{S}], the allowable number of times kₐ, information indicating a performance index, and a desired performance index (target value) q as input, estimates a threshold candidate θ′ such that the number of sections determined to be anomalous per predetermined section length T, which is a part of the data set Z, satisfies a predetermined criterion by using the allowable number of times kₐ (S120), and outputs the estimated threshold candidate θ′. It can be said that the anomaly score data set Z is a set of anomaly scores (data batches Zₛ=[z_{s,1}, . . . , z_{s,T}]) per predetermined section length T, which is a part of the time-series target data. The data set Y and the data set Z used in the allowable number setting unit 110 may be the same data set (Y=Z) or different data sets (Y≠Z). Further, data set Y may not include anomalous data, and the data set Z may or may not include anomalous data.

As describe above, in the present embodiment, the false positive rate is used as the performance index, and the information about the performance index indicates the false positive rate.

The threshold estimation unit 120 includes a detection number counting unit 121, an anomaly determination unit 122, a performance index calculation unit 123, and a threshold estimation unit 124 and performs the processing in S120 described above.

<Detection Number Counting Unit 121>

The detection number counting unit 121 receives the anomaly score data set Z as input, prepares P threshold candidates θₚ, calculates the number of times kₛ (θₚ) that an anomaly is detected in the anomaly scores Zₛ=[z_{s,1}, . . . , z_{s,T}] per predetermined section length T (S121) for each of the threshold candidates θₚ, and outputs the calculation results. Note that P is an integer of 2 or more, and p=1, . . . , P.

For example, the number of detection times for each batch Zₛ is calculated by the following formula:

$$\\ \begin{matrix}[ Math . 8 ] & \\ {k}_{s} ( {θ}_{p} ) = {\sum }_{t = 1}^{T} {I}_{{θ}_{p}} ( {z}_{s , t} ) , where & ( 6 )\end{matrix}$$

$$\\ \begin{matrix}[ Math . 9 ] & \\ {I}_{{θ}_{p}} ( {z}_{s , t} ) = \{ \begin{matrix}1 & ( {z}_{s , t} \geq {θ}_{p} ) \\ 0 & ( {z}_{s , t} < {θ}_{p} )\end{matrix} & \end{matrix}$$

is applied.

The detection number counting unit 121 calculates a frequency distribution of the anomaly scores in normal data batches, for example, and uses quartiles from a minimum value (or a theoretical minimum value of the anomaly scores) to a maximum value as the P threshold candidates θₚ. These are used without narrowing down the candidates in iterations.

<Anomaly Determination Unit 122>

The anomaly determination unit 122 receives P×S items of the number of times kₛ (θₚ) and the allowable number of times kₐ as input, and when the number of times kₛ (θₚ) exceeds the allowable number of times kₐ, the anomaly determination unit 122 determines that the target data corresponding to the anomaly scores Zₛ=[z_{s,1}, . . . , z_{s,T}] is anomalous (S122), and outputs P×S determination results aₛ(θₚ).

That is, based on the provided allowable number of times kₐ, the anomaly determination is performed on each threshold candidate θₚ and each batch Zₛ. When the number of detection times exceeds the provided allowable number of times kₐ, the anomaly determination unit 122 determines that the corresponding determination target is anomalous. The determination result aₛ(θₚ) for each batch is calculated as follows.

[Math. 10]

aₛ(θₚ)=Iₖ_{ₐ}(kₛ(θₚ)) (7)

Here, aₛ(θₚ)=1 indicates that the s-th batch is determined to be anomalous. That is, the following is applied.

$$\\ \begin{matrix}[ Math . 11 ] & \\ {I}_{{k}_{a}} ( {k}_{s} ( {θ}_{p} ) ) = \{ \begin{matrix}1 & ( {k}_{s} ( {θ}_{p} ) > {k}_{a} ) \\ 0 & ( {k}_{s} ( {θ}_{p} ) \leq {k}_{a} )\end{matrix} & \end{matrix}$$

<Performance Index Calculation Unit 123>

The performance index calculation unit 123 receives the P×S determination results aₛ (θₚ) as input, calculates P performance indexes FPR(θₚ) from the P×S determination results aₛ (θₚ) for each batch s (S123), and outputs the calculation results.

In the present embodiment, the false positive rate is used as a performance index, and the performance index is calculated as follows.

$$\\ \begin{matrix}[ Math . 12 ] & \\ FPR ( {θ}_{p} ) = \frac{1}{S} {\sum }_{s = 1}^{S} {a}_{s} ( {θ}_{p} ) & ( 8 )\end{matrix}$$

As the performance index, any suitable performance index for the anomaly score data set Z may be used. In a situation where the data set Z only includes normal data, a performance index selected based on the premise that there is only normal data may be used. For example, a false positive rate may be used. In a situation where the data set Z includes normal data and anomalous data, a performance index selected based on the premise that there are normal data and anomalous data may be used. For example, a false positive rate, a precision rate, a recall rate, or the like may be used. Any one of these indexes is selected, and the formula (8) is replaced with the definition of the selected performance index.

<Threshold Estimation Unit 124>

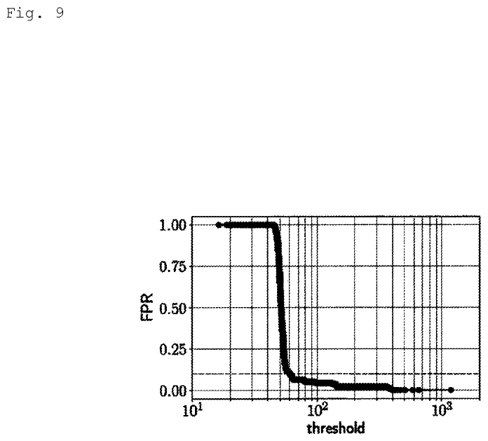

The threshold estimation unit 124 receives a desired performance index q and the P performance indexes FPR (θₚ) as input, selects a threshold candidate θₚ for achieving the desired performance index q by using the performance index FPR (θₚ) from among the P threshold candidates θₚ, estimates the selected threshold candidate θₚ as a threshold candidate θ′ (S124), and outputs the threshold candidate θ′. The threshold estimation unit 124 selects, for example, a threshold candidate θₚ corresponding to the highest false positive rate from among the threshold candidates θₚ that can achieve the desired false positive rate q to be estimated as a threshold candidate θ′. Alternatively, the threshold estimation unit 124 estimates a threshold candidate θ′ by linear interpolation of the threshold that achieves the maximum false positive rate not exceeding q and the threshold that achieves the minimum false positive rate exceeding q from among the threshold candidates that achieve the desired false positive rate. For example, the correspondence between the threshold candidate θₚ and the false positive rate as illustrated in FIG. 9 is obtained. From this, a threshold candidate θₚ for achieving the desired false positive rate q (=0.1) indicated by the dashed line in FIG. 9 is selected.

<End Determination Unit 130>

The end determination unit 130 receives a threshold candidate θ′ as input and repeats the processing in S120 and S130 until the estimation of the threshold candidate converges. If the estimation has not converged, the end determination unit 130 outputs the threshold candidate θ′ to the parameter estimation unit 111, and if the estimation has converged, the end determination unit 130 acquires the threshold candidate at the time of convergence as a threshold θ (S130) and outputs the acquired threshold θ as an output value of the threshold acquisition apparatus.

The end determination unit 130 compares, for example, the estimated new threshold candidate θ′ with the previous threshold candidate, and if the error therebetween is within a certain range, it is deemed that the convergence has been achieved. Further, for example, when the iteration has reached a predetermined number of times, it is deemed that the convergence has been achieved.

<Effects>

According to the present embodiment, with the above configuration, an appropriate threshold for anomaly determination can be automatically acquired.

### Modification Example

In the present embodiment, the target data is an acoustic data set. However, the target data may be any other data set that can be an anomaly detection target. For example, a video data set, a data set including some kind of logs, or the like may be the target data.

In the present embodiment, the reconstruction error is defined as the anomaly score. However, the anomaly score may be any information as long as the anomaly score indicates the degree of anomaly of the target data. In addition, in the present embodiment, a value that increases as the degree of anomaly increases is used as the anomaly score. However, a value that decreases as the degree of anomaly increases may be used as the anomaly score. In short, any anomaly score may be used as long as normality and anomaly can be determined based on the magnitude relation with the threshold.

### Other Modification Examples

The present invention is not limited to the above embodiments and modifications. For example, the various kinds of processing described above may not only be executed in chronological order according to the description, but also be executed in parallel or individually in accordance with the processing capacity of the apparatus executing the processing or as needed. In addition, changes can be made as appropriate without departing from the gist of the present invention.

<Program and Recording Medium>

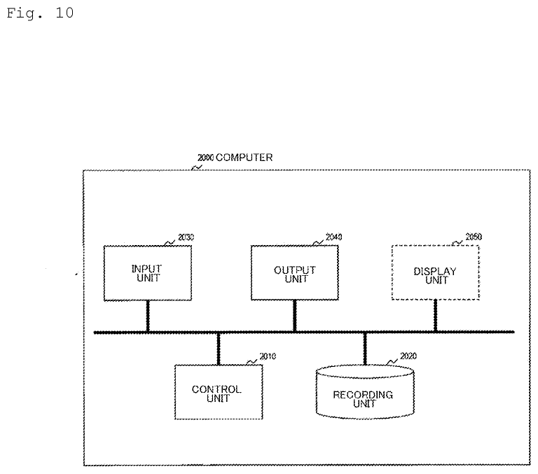

The various kinds of processing described above can be implemented by causing a recording unit 2020 of a computer illustrated in FIG. 10 to read a program for executing each step of the above method and causing a control unit 2010, an input unit 2030, an output unit 2040, etc. to perform operations.

The program describing the processing content can be recorded on a computer-readable recording medium. The computer-readable recording medium may be, for example, a magnetic recording device, an optical disk, a photomagnetic recording medium, a semiconductor memory, or the like.

In addition, the distribution of this program is performed, for example, by selling, transferring, or leasing a portable recording medium such as a DVD or a CD-ROM in which the program is recorded. Further, the program may be stored in a storage device of a server computer, and the program may be distributed by transferring the program from the server computer to another computer via a network.

A computer that executes such a program, for example, first stores a program recorded on a portable recording medium or a program transferred from a server computer in its own storage device. Next, when the processing is executed, the computer reads the program stored in its own recording medium and executes the processing according to the read program. In addition, as another execution form of this program, a computer may read the program directly from a portable recording medium and execute the processing according to the program, and further, each time the program is transferred from the server computer to the computer, the computer may sequentially execute the processing in accordance with the received program. In addition, the above processing may be executed by a so-called ASP (application service provider) type service that realizes the processing function only by the execution instruction and result acquisition without transferring the program from the server computer to this computer. The program in the present embodiment includes information to be used for processing by a computer and equivalent to the program (data that is not a direct command to the computer but has a property of defining the processing of the computer, etc.).

Further, in the present embodiment, the present apparatus is configured by executing a predetermined program on the computer. However, at least a part of these processing contents may be achieved by hardware.

1. A computer-implemented apparatus for determining whether an anomaly score acquired from a target data is normal or anomalous based on a threshold, the apparatus comprising a circuit configured to execute a method comprising:
setting an allowable number of times such that the number of anomaly scores determined to be anomalous included in a set of anomaly scores per predetermined section length, which is a part of time-series data that do not include an anomalous data, does not exceed the allowable number of times; and
estimating a threshold candidate such that the number of sections determined to be anomalous per predetermined section length satisfies a predetermined criterion by using the allowable number of times, wherein the number of sections is a part of time-series data;
determining the threshold candidate as the threshold; and
causing determining whether the anomaly score acquired from the target data is anomalous based on the threshold.

2. The computer-implemented apparatus according to claim 1, the circuit further configured to execute a method comprising:
obtaining a mean detection rate λ(θ′) at a threshold candidate θ′ from a set of anomaly scores Yᵢ=[y_{i,1}, . . . , y_{i,T}] per predetermined section length T, which is a part of time-series acoustic signals;
calculating the number of times k that an anomaly is detected in a predetermined section length T by a Poisson distribution based on the mean detection rate λ(θ′),
determining a probability p (k>kₐ; Tλ(θ′)) that the number of times k is greater than an allowable number of times kₐ;
acquiring a minimum allowable number of times kₐ at which a probability p (k>kₐ; Tλ(θ′)) is equal to or less than a predetermined significance level α;
calculating, when P is an integer of 2 or more, and p=1, . . . , P, the number of times kₛ(θₚ) that an anomaly is detected in anomaly scores Zₛ=[z_{s,1}, . . . , z_{s,T}] per predetermined section length T for each of P threshold candidates θₚ;
determining that acoustic signals corresponding to the anomaly scores Zₛ=[z_{s,1}, . . . , z_{s,T}] are anomalous when the number of times kₛ(θₚ) exceeds the allowable number of times kₐ;
calculating a performance index FPR (θₚ) from a determination result aₛ (θₚ) associated with the determining that acoustic signals corresponding to the anomaly scores are anomalous;
repeating until estimation of the threshold candidate converges:
selecting a threshold candidate θₚ for achieving a desired performance index q by using the performance index FPR (θₚ) from among the P threshold candidates θₚ to be the threshold candidate θ′; and
determining the threshold at a time of convergence as the threshold.

3. A computer-implemented method for acquiring a threshold for determining whether an anomaly score acquired from a target data is normal or anomalous based on a threshold, the method comprising:
setting an allowable number of times such that the number of anomaly scores determined to be anomalous included in a set of anomaly scores per predetermined section length, which is a part of time-series data that do not include an anomalous data, does not exceed the allowable number of times; and
estimating a threshold candidate such that the number of sections determined to be anomalous per predetermined section length satisfies a predetermined criterion by using the allowable number of times, wherein the number of sections is a part of time-series data;
determining the threshold candidate as the threshold; and
causing determining whether the anomaly score acquired from the target data is anomalous based on the threshold.

4. The computer-implemented method according to claim 3, the method further comprising:
obtaining a mean detection rate λ(θ′) at a threshold candidate θ′ from a set of anomaly scores Yᵢ=[y_{i,1}, . . . , y_{i,T}] per predetermined section length T, which is a part of time-series acoustic signals;
calculating that models the number of times k that an anomaly is detected in a predetermined section length T by a Poisson distribution based on the mean detection rate λ(θ′) and calculates a probability p (k>kₐ; Tλ(θ′)) that the number of times k is greater than an allowable number of times kₐ;
acquiring a minimum allowable number of times kₐ at which a probability p (k>kₐ; Tλ(θ′)) is equal to or less than a predetermined significance level α;
calculating, when P is an integer of 2 or more, and p=1, . . . , P, the number of times kₛ (θₚ) that an anomaly is detected in anomaly scores Zₛ=[z_{s,1}, . . . , z_{s,T}] per predetermined section length T for each of P threshold candidates θₚ;
determining that acoustic signals corresponding to the anomaly scores Zₛ=[z_{s,1}, . . . , z_{s,T}] are anomalous when the number of times kₛ (θₚ) exceeds the allowable number of times kₐ;
calculating a performance index FPR (θₚ) from a determination result aₛ (θₚ) obtained in the determining; and
repeating until estimation of the threshold candidate converges:
selecting a threshold candidate θₚ for achieving a desired performance index q by using the performance index FPR (θₚ) from among the P threshold candidates θₚ to be the threshold candidate θ′; and
determining the threshold at a time of convergence as the threshold.

5. A system for acquiring a threshold for determining whether an anomaly score acquired from target data is normal or anomalous, the apparatus comprising a processor configured to execute a method comprising:
setting an allowable number of times such that the number of anomaly scores determined to be anomalous included in a set of anomaly scores per predetermined section length, which is a part of time-series data that do not include anomalous data, does not exceed the allowable number of times; and
estimating a threshold candidate such that the number of sections determined to be anomalous per predetermined section length satisfies a predetermined criterion by using the allowable number of times, wherein the number of sections is a part of time-series data signals;
determining the threshold candidate as the threshold; and
causing determining whether the anomaly score acquired from the target data is anomalous based on the threshold.

6. The system according to claim 5, the processor further configured to execute a method comprising:
obtaining a mean detection rate λ(θ′) at a threshold candidate θ′ from a set of anomaly scores Yᵢ=[y_{i,1}, . . . , y_{i,T}] per predetermined section length T, which is a part of time-series data;
calculating the number of times k that an anomaly is detected in a predetermined section length T by a Poisson distribution based on the mean detection rate λ(θ′),
calculating a probability p (k>kₐ; Tλ(θ′)) that the number of times k is greater than an allowable number of times kₐ;
acquiring a minimum allowable number of times kₐ at which a probability p (k>kₐ; Tλ(θ′)) is equal to or less than a predetermined significance level α;
calculating, when P is an integer of 2 or more, and p=1, . . . , P, the number of times kₛ(θₚ) that an anomaly is detected in anomaly scores Zₛ=[z_{s,1}, . . . , z_{s,T}] per predetermined section length T for each of P threshold candidates θₚ;
determining that data corresponding to the anomaly scores Zₛ=[z_{s,1}, . . . , z_{s,T}] are anomalous when the number of times kₛ(θₚ) exceeds the allowable number of times kₐ;
calculating a performance index FPR (θₚ) from a determination result aₛ (θₚ) obtained in the determining;
repeating until estimation of the threshold candidate converges:
selecting a threshold candidate θₚ for achieving a desired performance index q by using the performance index FPR (θₚ) from among the P threshold candidates θₚ to be the threshold candidate θ′; and
determining the threshold at a time of convergence as the threshold.

7. (canceled)

8. The computer-implemented apparatus according to claim 1, the target data including sound data, and the time-series data including time-series acoustic signals.

9. The computer-implemented apparatus according to claim 1, the target data including video data, and the time-series data including time-series video signals.

10. The computer-implemented apparatus according to claim 9, the circuit further configured to execute a method comprising:
obtaining a mean detection rate λ(θ′) at a threshold candidate θ′ from a set of anomaly scores Yᵢ=[y_{i,1}, . . . , y_{i,T}] per predetermined section length T, which is a part of time-series video signals;
calculating the number of times k that an anomaly is detected in a predetermined section length T by a Poisson distribution based on the mean detection rate λ(θ′);
determining a probability p (k>kₐ; Tλ(θ′)) that the number of times k is greater than an allowable number of times kₐ;
acquiring a minimum allowable number of times kₐ at which a probability p (k>kₐ; Tλ(θ′)) is equal to or less than a predetermined significance level α;
calculating, when P is an integer of 2 or more, and p=1, . . . , P, the number of times kₛ (θₚ) that an anomaly is detected in anomaly scores Zₛ=[z_{s,1}, . . . , z_{s,T}] per predetermined section length T for each of P threshold candidates θₚ;
determining that video signals corresponding to the anomaly scores Zₛ=[z_{s,1}, . . . , z_{s,T}] are anomalous when the number of times kₛ(θₚ) exceeds the allowable number of times kₐ;
calculating a performance index FPR (θₚ) from a determination result aₛ (θₚ) associated with the determining that video signals corresponding to the anomaly scores are anomalous;
repeating until estimation of the threshold candidate coverages:
selecting a threshold candidate θₚ for achieving a desired performance index q by using the performance index FPR (θₚ) from among the P threshold candidates θₚ to be the threshold candidate θ′; and
determining the threshold at a time of convergence as the threshold.

11. The computer-implemented method according to claim 3, the target data including sound data, and the time-series data including time-series acoustic signals.

12. The computer-implemented apparatus according to claim 3, the target data including video data, and the time-series data including time-series video signals.

13. The system according to claim 5, the target data including sound data, and the time-series data including time-series acoustic signals.

14. The system according to claim 5, the target data including video data, and the time-series data including time-series video signals.
